(19) United States
(12) Patent Application Publication
(10) Pub. No.: US 2018/0351500 A1
(43) Pub. Date: Dec. 6, 2018

(54) SOLAR PANEL CANOPY HAVING THERMOSIPHONING

(71) Applicant: AMERISTAR SOLAR, LLC, BANKS, OR (US)

(72) Inventor: SIDNEY WILLIAM BOYK, BANKS, OR (US)

(21) Appl. No.: 15/994,692

(22) Filed: May 31, 2018

Related U.S. Application Data
(60) Provisional application No. 62/514,130, filed on Jun. 2, 2017.

(51) Int. Cl. H02S 20/10; E04B 1/24; H02S 30/10; H02S 40/38; H02S 40/42; H02S 40/34

(52) U.S. Cl. CPC H02S 20/10; E04B 1/24; H02S 40/34; H02S 40/38; H02S 40/425; H02S 30/10

(57) ABSTRACT

A solar canopy structure has a framework having legs and an upper frame, the upper frame having a center ridge member, and at least two sloped portions on opposite sides of the center ridge member, the sloped portions connected to legs at one end of the sloped portions and to the center ridge member at a second end of the sloped portion, a gap in the framework adjacent the center ridge member, solar panels mounted to the framework at the sloped portions, an optional structure underneath the framework such that a lower gap exists between the solar panels mounted in the framework and the structure to allow cool air to enter the lower gap and flow along the underside of the solar panels to the gap in the framework adjacent the center ridge member, and an electrical connection between the solar panels and the structure, such that the structure can draw power from the solar panels.

### CROSS REFERENCE TO RELATED APPLICATION

This is application claims priority to and the benefit of U.S. Provisional Application No. 62/514,130 filed Jun. 2, 2017, which is incorporated by reference in its entirety.

### BACKGROUND

Temporary shelters, such as tents, trailers and ‘modules’ often get deployed in remote locations, or in emergency situations where they have little or no access to a power grid. The terms ‘trailers’ and ‘modules’ refer to the temporary buildings often associated with construction sites and temporary classrooms. Power to these structures typically comes from large, towable gas or diesel generators.

However, flexible solar panels offer an attractive option to reduce the use of, or replace completely, the large, noisy and polluting generators. Tents, having flexible walls and ceilings, seem to make a good fit for installation of flexible solar panels as part of their structure.

An issue arises with most solar panels, regardless of whether they are monocrystalline, polycrystalline or thin film. As the panels heat up, their transfer characteristic, which is the ability to convert sunlight to voltage, becomes less efficient. Given that these panels deploy in sunshine to operate, this causes many problems. When they have become integrated into the materials of a structure, with no cooling, the problem becomes more extreme.

### BRIEF DESCRIPTION OF THE DRAWINGS

FIG. 1 shows a top view of a structure having a solar panel canopy.

FIG. 2 shows a side view of a structure having a solar panel canopy.

FIGS. 3 and 4 show end views of a structure having a solar panel canopy.

FIG. 5 shows a more detailed view of track mounted, interconnectable solar panels.

### DETAILED DESCRIPTION OF THE EMBODIMENTS

The below discussion focuses on the use of a solar canopy for tents and other temporary structures. This is merely for purposes of discussion and not intended to limit the use of the canopy for that purpose. The canopy could may consist of a standalone structure usable for any outdoor activity that would benefit from availability of power. The term solar canopy structure refers to a solar canopy in accordance with the embodiments deployed with a structure underneath it. The term solar canopy refers to the solar canopy without the structure.

Solar panels, whether polycrystalline or monocrystalline silicon, or thin film, suffer when they heat up. Since they generally reside in sunlight areas, heat management becomes a key factor affecting their performance. For each degree of rise in the panel temperature, the panel will lose about ½% efficiency. A typical installation will have the panel gaining 50-60 degrees of temperature. This causes a loss of between 20-30% efficiency. Being able to cool the panels, without consuming any of their generated power, makes their deployment much more cost effective.

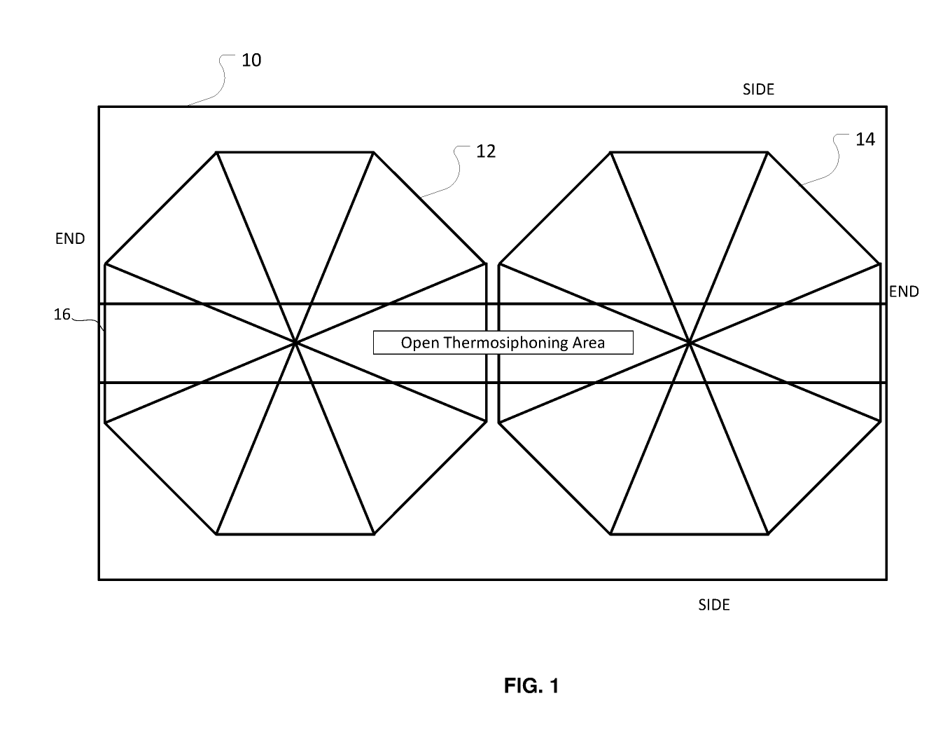

FIG. 1 shows a top view of a solar canopy structure with a solar canopy 10 erected above a pair of octagonal tent structures 12 and 14. The canopy consists of a framework structure, typically of steel tubing, although other materials may be used. A ridge cover 16 extends in a longitudinal direction above the structures being covered by the canopy. One should note that the term longitudinal as used here refers to the direction of a long axis of the typically rectangular structure. However, as some tents or other structures may be square, one can designate whichever direction to be longitudinal. The ridge cover may be metal, canvas or any other material that can form the ridgeline of the canopy structure.

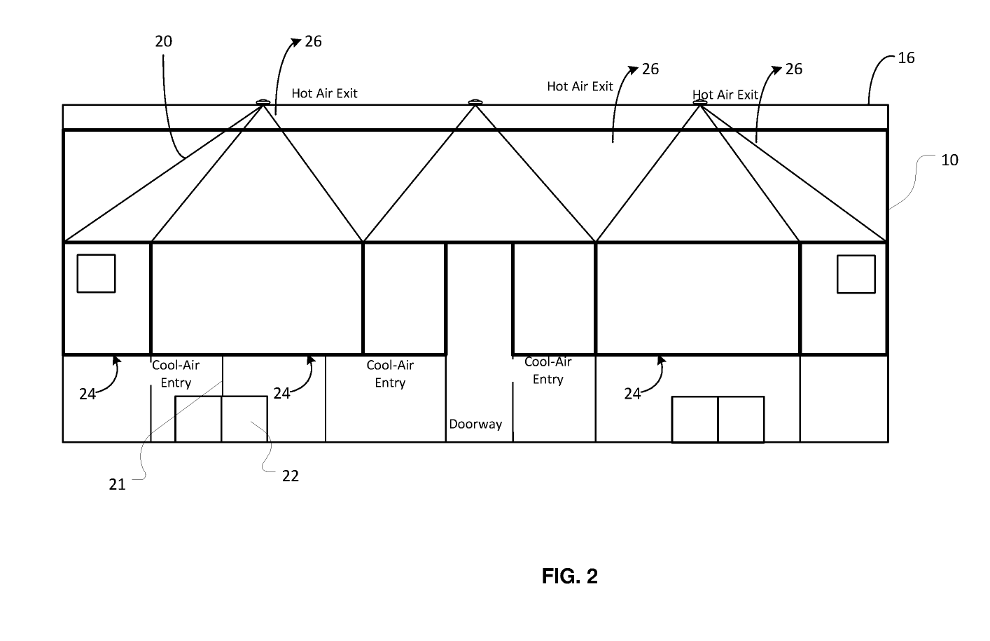

FIG. 2 shows a side view of a canopy 10 covering a rectangular structure or tent 20. The ridge cover 16 will typically be at the apex of the canopy structure above the apex of the structures being covered. However, it is possible that the legs of the canopy structure could be adjustable to allow it to be off-center. This may have advantages if one of the sides of the structure has better exposure to sunlight. That side may be tilted more towards the sun, or the framework could be adjustable to allow the ridge cover to be shifted to an asymmetrical position to allow the more exposed side to have more surface area. The panels reside on an angled ‘roof’ sloping down on either side from the ridge cover, and then may drop vertically along the walls of the structure, if desired. Accommodations may be provided for doors windows and other openings, if the panels are to extend down the sides.

At the bottom of the framework, gaps exist between the structure being covered and the canopy framework to allow cool air closer to the ground to enter in between the gaps between the solar panels mounted in the canopy framework and the structure. Typically, the framework will have no panels lower towards the ground, and may not even have any panels below the edge of the roof. Allowing the cool air to enter takes advantage of a chimney effect that occurs, referred to a thermosiphoning, where the cool air rises along the underside of the panels towards the top of the structure. This increases their efficiency as well as cooling the structure underneath. The cool air enters the gap 24 between the canopy structure and the panels, and then hot air 26 exits in a gap between the panels and the ridge cover 16.

Electrically, the solar panels are to provide electricity to the interior of the structure 20. The solar panels may feed a battery structure such as 22, which is then electrically connected to electrical equipment inside the structure. The electrical equipment then draws power from the battery structure. Alternatively, the electrical equipment could draw power directly from the transformers on the solar panels through connection 21, or there could be a switch to allow selection of which mode is to be used.

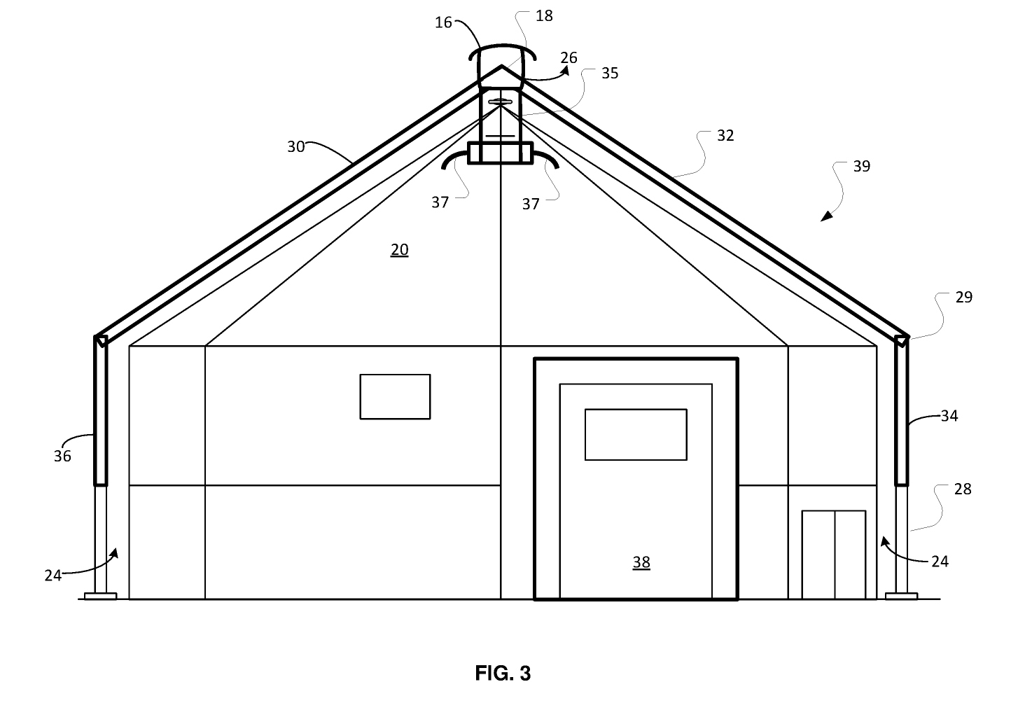

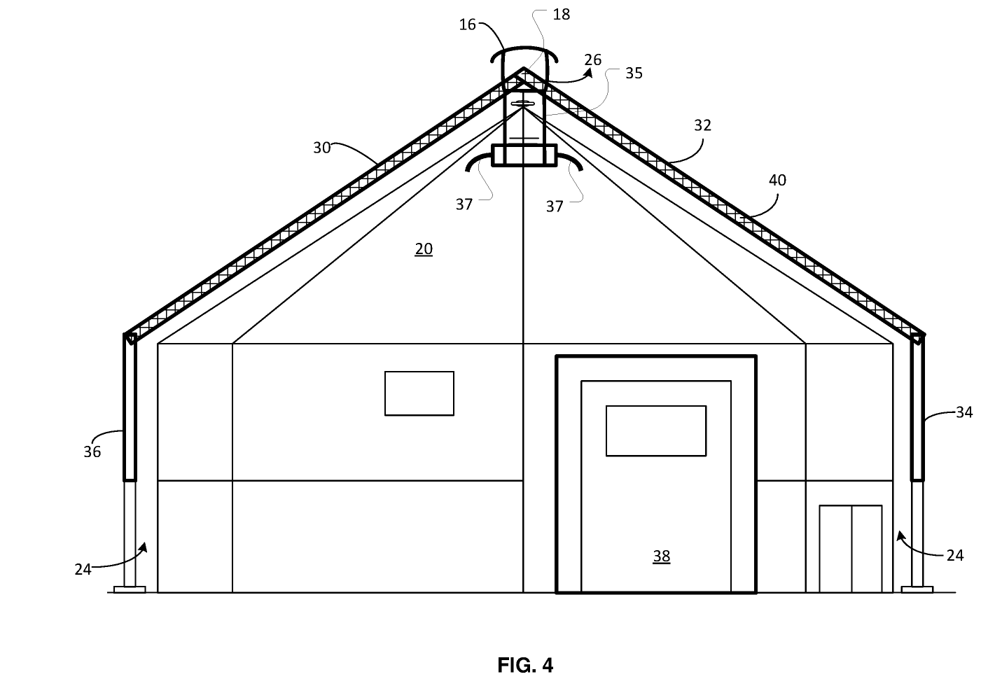

FIGS. 3 and 4 show end views of the structure 20. The framework forms a frame into which the solar panels may be mounted. The upper frame structure 39 has sloped portions 30 and 32 on either side of the center ridge member 18 covered by the ridge cover 16. In some embodiments, the ridge cover may act as the center ridge member to which the sloped portions attach. The upper frame structure 39 is supported by legs such as 28. The upper frame structure may have multiple support ribs that parallel the sloped portions 30 and 32 and span the gap between the joint such as 29 at top of the legs and the apex. In this view, the multiple sloped support ribs would repeat on the other side of 30 and 32 going into the page to the other end of the framework in a longitudinal direction. The solar panels would mount in between the sloped support ribs.

Also shown in FIGS. 3 and 4 is a heating ventilation air conditioning (HVAC) unit 35 suspended from the center ridge member and providing heating and cooling to the structures through the conduits 37. Heating and cooling the temporary structures can be problematic because of the power needs and the lack of mobility caused by large HVAC ground mounted units. However, with the availability of the power from the solar panels, and the framework to provide mounting opportunities, the HVAC units 35 can be suspended from the center ridge members in the longitudinal direction to provide heating and cooling for the tent structures.

Typically, the panels will reside in the framework on these sloped areas, but as mentioned previously, they could extend down the sides 34 and 36 as well. The ends of the structure may offer more convenient access to the structure such as the door 38 and so may not have any panels below the roof line, but may include them if desired. The framework may have mounts for the panels on all sides so the panels can be moved to the side with the greatest sunlight exposure. The cool air enters the gap 24 between the tube leg or tube 28 and the structure and exits as hot air 26 at the top of the structure below the ridge cover 16.

FIG. 4 shows another end view, showing the installed panels 40 into the canopy framework. One should note that the panels shown have insulation on the back of the panel. While this helps preserve the operation of the panels, it may slow down the cooling effect of the thermosiphoning. Without insulation, the panels may cool more rapidly and more effectively in response to the thermosiphoning. As can be seen at the top of the structure, the ridge cover 16 is vertically offset from the sloped portions to allow a hot air exit 26. The vertical offset provides an opening between the panels and the ridge cover through which the hot air may exit.

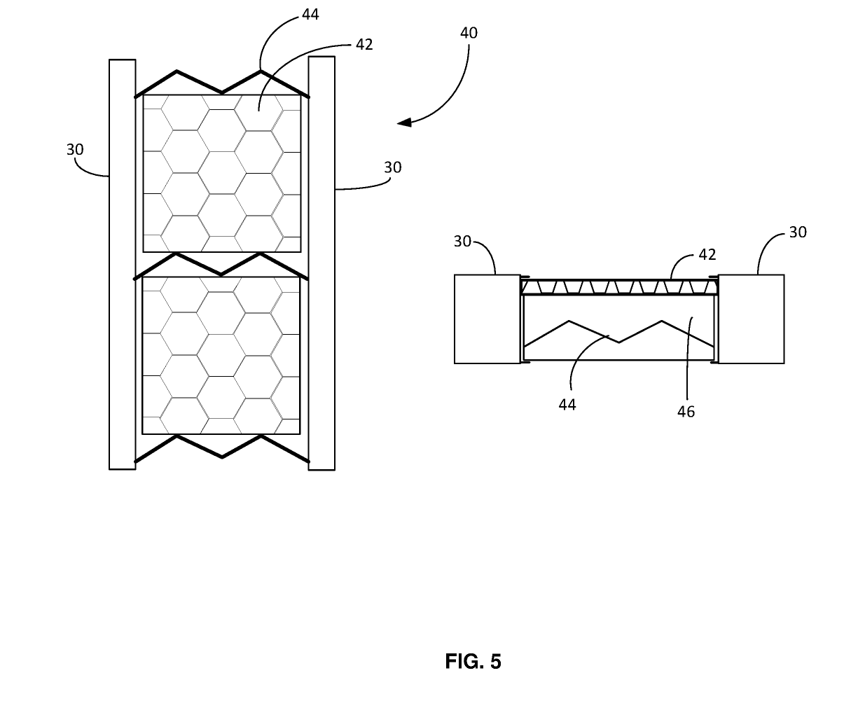

FIG. 5 shows a more detailed view of the structure track and the panels 40 inserted into the framework. The example here is of the sloped side of the framework 30 with the panel 40 inserted into the framework. One should note that this is merely an example and the panels could be inserted anywhere in the framework desired, included mounted to the legs on the sides of the canopy as mentioned previously. The panel has photovoltaic elements such as 42. The edge of the panel has a connector 44 that allows the two panels to connect. The side view of the panel 40 shows the element 42 on one side and the insulation on the other at 46. As mentioned previously, the lack of insulation would widen the gap and allow for both more air movement and contact between the panels and moving air.

In this manner, one can cool an array of solar panels using thermosiphoning, in which cool air enters gaps between the panels and the framework and travels up the backs of the panels and then vents out of the top. This increases the efficiency of the panels and possible assists with or maintains cooling of the interior of the structure. The canopy can stand by itself or cover a structure. If the canopy does not cover a structure, there will be no gaps to allow thermosiphoning, but the backs of the panels will be open to the ambient atmosphere which will assist with keeping them cool.

Many modifications and variations may exist. The canopy show here is rectangular, but could be deployed in a square configuration. The emergency structures may have hexagonal or octagonal shapes, and the framework could mimic that structure. This may provide more surfaces at varying angles to allow higher levels of sunlight absorption by the photovoltaic cells. The canopy could also be pyramidal or round. The framework may be steel, aluminum, carbon fiber, fiberglass, etc., any material that can bear the weight of the panels and have good stability.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A solar canopy structure, comprising:
a framework having legs and an upper frame, the upper frame having a center ridge member, and at least two sloped portions on opposite sides of the center ridge member, the sloped portions connected to legs at one end of the sloped portions and to the center ridge member at a second end of the sloped portion;
a gap in the framework adjacent the center ridge member;
solar panels mounted to the framework at the sloped portions;
a structure underneath the framework such that a lower gap exists between the solar panels mounted in the framework and the structure to allow cool air to enter the lower gap and flow along the underside of the solar panels to the gap in the framework adjacent the center ridge member; and
an electrical connection between the solar panels and the structure, such that the structure can draw power from the solar panels.

2. The solar canopy of claim 1, further comprising a ridge cover separate from the center ridge member.

3. The solar canopy of claim 1, wherein the center ridge member comprises a ridge cover.

4. The solar canopy of claim 1, further comprising multiple sloped portions between the legs and the center ridge member arranged in parallel in a longitudinal fashion.

5. The solar canopy of claim 1, further comprising solar panels mounted to the framework at the legs.

6. The solar canopy of claim 1, wherein the legs comprise adjustable legs.

7. The solar canopy of claim 1, wherein the center ridge member is adjustable to allow the canopy to be deployed in an asymmetrical configuration.

8. The solar canopy of claim 1, further comprising a battery to receive electrical power from the solar panels and provide storage.

9. The solar canopy structure of claim 1, further comprising an electrical connection between the solar panels and electrical equipment inside the structure.

10. The solar canopy structure of claim 1, further comprising a heating ventilation and air conditioning unit suspended from the center ridge member.

11. A solar canopy, comprising:
a framework having legs and an upper frame, the upper frame having a center ridge member, and at least two sloped portions on opposite sides of the center ridge member, the sloped portions connected to legs at one end of the sloped portions and to the center ridge member at a second end of the sloped portion;
a gap in the framework adjacent the center ridge member; and
solar panels mounted to the framework at the sloped portions.

12. The solar canopy of claim 11, further comprising a ridge cover separate from the center ridge member.

13. The solar canopy of claim 11, wherein the center ridge member comprises a ridge cover.

14. The solar canopy of claim 11, further comprising multiple sloped portions between the legs and the center ridge member arranged in parallel in a longitudinal fashion.

15. The solar canopy of claim 11, further comprising solar panels mounted to the framework at the legs.

16. The solar canopy of claim 11, wherein the legs comprise adjustable legs.

17. The solar canopy of claim 11, wherein the center ridge member is adjustable to allow the canopy to be deployed in an asymmetrical configuration.

18. The solar canopy of claim 11, further comprising a battery to receive electrical power from the solar panels and provide storage.
